(19) United States
(12) Patent Application Publication
(10) Pub. No.: US 2008/0226518 A1
(43) Pub. Date: Sep. 18, 2008

(54) SUBSTRATE PROCESSING APPARATUS

(75) Inventor: Ryo NONAKA, Nirasaki-shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: TOKYO ELECTRON LIMITED, Tokyo (JP)

(21) Appl. No.: 12/045,931

(22) Filed: Mar. 11, 2008

Related U.S. Application Data
(60) Provisional application No. 60/941,815, filed on Jun. 4, 2007.

(30) Foreign Application Priority Data
Mar. 12, 2007 (JP) 2007-061280

(51) Int. Cl. B01J 19/00

(52) U.S. Cl. 422/198

(57) ABSTRACT

A substrate processing apparatus includes: a processing chamber for accommodating and processing a target substrate therein; a supporting member for supporting the target substrate in the processing chamber; a processing gas supply mechanism for supplying, into the processing chamber, a processing gas which generates radicals for processing the target substrate; a catalytic heating element disposed to face the target substrate, the element radiating heat when an electric power is applied thereto and generating the radicals by a catalytic action as the processing gas contacts the catalytic heating element; and a power supply mechanism for supplying the power to the catalytic heating element to allow the catalytic heating element to radiate the heat. The apparatus further includes a driving mechanism for moving the target substrate close to or apart from the catalytic heating element by means of moving the supporting member, to thereby control a temperature of the target substrate.

### FIELD OF THE INVENTION

The present invention relates to a substrate processing apparatus for performing a process on a target substrate such as a semiconductor wafer, an LCD (Liquid Crystal Display) glass substrate, or the like by radicals of a processing gas generated by a catalytic action.

### BACKGROUND OF THE INVENTION

Conventionally, in the field of manufacture of semiconductor devices, LCD devices, and the like, there has been employed a substrate processing apparatus for performing such a process as etching, CVD (Chemical Vapor Deposition), or the like by way of generating plasma and having the plasma act on a target substrate. Further, there is also known a substrate processing apparatus for performing an ashing process or the like by radicals of a processing gas without using plasma, wherein the radicals are generated by a catalytic action as the processing gas such as, e.g., a hydrogen gas contacts a heated catalyzer.

In the substrate processing apparatus which generates the radicals by the above-described catalytic action, an electric power is applied to a catalytic heating element made of, e.g., W, SiC, Pt, or the like so that the catalytic heating element emits heat of a temperature equal to or greater than, e.g., about 1000° C. Further, a target substrate is mounted on a mounting table having a resistance heater therein and is heated to a specific temperature. The radicals generated by the contact of the processing gas with the catalytic heating element are allowed to act on the heated target substrate, so that the ashing process or the like is carried out.

As a method for heating the target substrate by means of the resistance heater, there is known a technique for controlling a temperature of a wafer by adjusting a distance between a wafer and a heating plate on which the wafer is supported via supporting pins which are configured to be movable up and down (see, for example, Japanese Patent Laid-open Application No. H7-254545). Moreover, there is also known a technique for heating the target substrate by bringing the target substrate close to a heat radiating lamp (see, for example, Japanese Patent Laid-open Application No. 2002-176002).

As described above, in the above-mentioned substrate processing apparatus which generates the radicals by the catalytic action, an electric power is applied to the catalytic heating element to allow it to radiate heat, while concurrently heating the target substrate by means of a resistance heater or the like embedded in the substrate mounting table for mounting the target substrate thereon, whereby the radicals of the processing gas are generated by the catalytic heating element, and the ashing process or the like is executed. As for such substrate processing apparatus, however, it is required to reduce manufacturing costs as well as a cost for substrate processing.

### SUMMARY OF THE INVENTION

In view of the above, the present invention provides a substrate processing apparatus capable of reducing its manufacturing costs and also capable of reducing a cost for substrate processing in comparison with conventional cases.

In accordance with an aspect of the present invention, there is provided a substrate processing apparatus including:

a processing chamber for accommodating and processing a target substrate therein;

a supporting member for supporting the target substrate in the processing chamber;

a processing gas supply mechanism for supplying, into the processing chamber, a processing gas which generates radicals for processing the target substrate;

a catalytic heating element disposed to face the target substrate, the catalytic heating element radiating heat when an electric power is applied thereto and generating the radicals by a catalytic action as the processing gas contacts the catalytic heating element;

a power supply mechanism for supplying the power to the catalytic heating element to allow the catalytic heating element to radiate the heat; and

a driving mechanism for moving the target substrate close to or apart from the catalytic heating element by means of moving the supporting member, to thereby control a temperature of the target substrate.

Preferably, a plate-shaped member made of a material capable of transmitting the radiant heat from the catalytic heating element is disposed between the catalytic heating element and the supporting member, and the plate-shaped member is provided with a number of through holes for allowing the radicals to pass therethrough.

Preferably, an internal pressure of the processing chamber on the catalytic heating element side of the plate-shaped member is set to be higher than an internal pressure of the processing chamber on the supporting member side of the plate-shaped member.

Preferably, the plate-shaped member is made of quartz.

Preferably, the catalytic heating element is made of a material selected from a group including W, SiC and Pt.

Preferably, the processing gas is a hydrogen gas.

In accordance with the present invention, a substrate processing apparatus capable of reducing its manufacturing costs and also capable of reducing a cost for substrate processing in comparison with conventional cases can be provided.

### BRIEF DESCRIPTION OF THE DRAWINGS

The above features of the present invention will become apparent from the following description of an embodiment given in conjunction with the accompanying drawings, in which:

FIG. 1 illustrates a schematic cross sectional configuration view of a substrate processing apparatus in accordance with an embodiment of the present invention; and

FIG. 2 illustrates a configuration view of a catalytic heating element of the substrate processing apparatus of FIG. 1.

### DETAILED DESCRIPTION OF THE EMBODIMENT

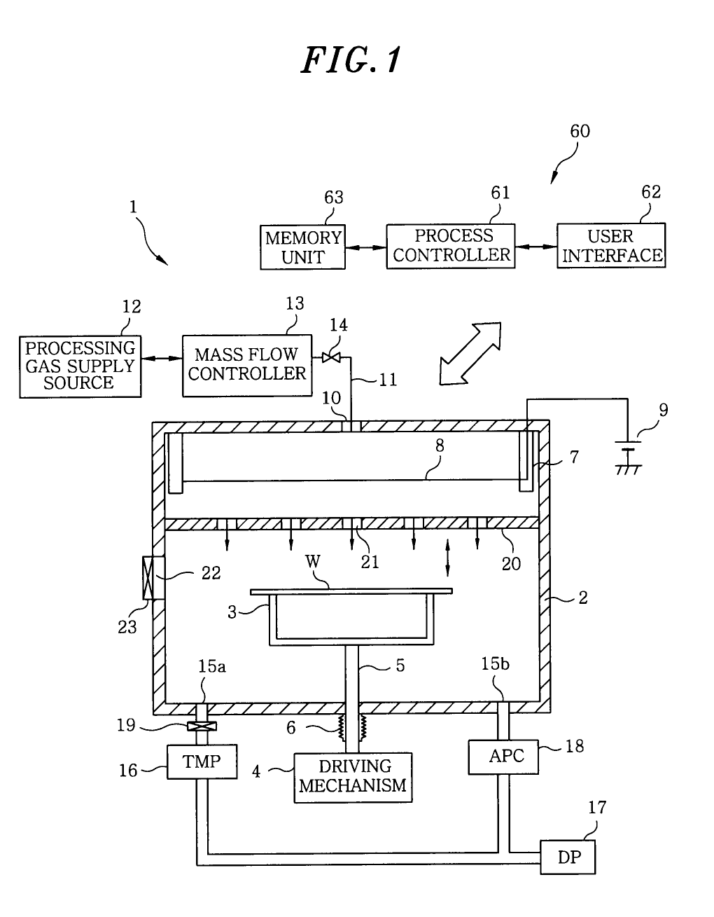

Hereinafter, an embodiment of the present invention will be described with reference to the accompanying drawings, which form a part hereof. FIG. 1 illustrates a schematic cross sectional configuration view of a substrate processing apparatus 1 in accordance with the embodiment of the present invention.

The substrate processing apparatus 1 includes a cylindrical processing chamber (processing vessel) 2 made of, for example, aluminum. Disposed in the processing chamber 2 is a plurality of (for example, three) supporting pins 3 uprightly installed at a bottom side of the processing chamber 2 to serve as a substrate supporting member. The supporting pins 3 are connected to a driving shaft 5 which is extended into the processing chamber 2 from a driving mechanism 4 disposed outside the processing chamber 2, and the supporting pins 3 are configured to be vertically movable by the driving mechanism 4. Further, a bellows 6 is provided to surround a portion of the driving shaft 5 exposed out of the processing chamber 2, and a gap between the driving shaft 5 and the processing chamber 2 is airtightly sealed thereby. On the supporting pins 3, a target substrate to be processed, for example, a semiconductor wafer W is mounted.

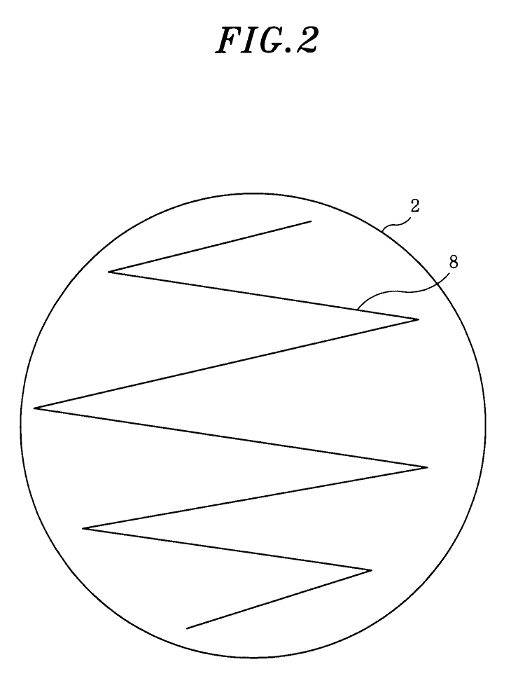

A catalytic heating element 8 is disposed at a ceiling side of the processing chamber 2 to face the semiconductor wafer W sustained on the supporting pins 3, wherein the catalytic heating element 8 is supported by an insulating supporting member 7. The catalytic heating element 8 is made of a material capable of radiating heat when an electric power is applied thereto and also capable of generating radicals by a catalytic action. The catalytic heating element 8 is made of any one of, e.g., W, SiC and Pt. Further, the catalytic heating element is formed in, e.g., a wire shape and arranged to be bent in, e.g., a zigzag pattern, thereby obtaining a sufficient contact area with the processing gas, as shown in FIG. 2. Moreover, the shape of the catalytic heating element 8 is not limited to the above example, but can be, e.g., a mesh shape or the like.

The catalytic heating element 8 is electrically connected to a DC power supply 9 which is provided outside the processing chamber 2 to serve as a power supply mechanism. When a DC power is applied to the catalytic heating element 8 from the DC power supply 9, the catalytic heating element 8 radiates heat, so that its temperature can be set to be high above or equal to, e.g., about 1000° C. Preferably, the inner surface of the processing chamber 2 is configured as a reflective surface that reflects the radiant heat from the catalytic heating element 8. If the inner surface of the processing chamber 2 is formed as the reflective surface, heating of the semiconductor wafer W to be described later can be carried out efficiently and, also, an excessive temperature rise of the processing chamber 2 itself can be suppressed. If this configuration is adopted, it is not preferable to form the processing chamber 2 with a stainless steel material in the aspect of preventing metal contamination of the semiconductor wafer W and the like, though the stainless steel material is a proper material for forming the processing chamber 2 in other cases. Instead, a pure aluminum material which is not subjected to anodic oxidization (aluminte treatment) may be preferably used, for example.

Further, a processing gas inlet 10 is provided at a ceiling portion of the processing chamber 2, and one end of a processing gas supply line 11 is connected to the processing gas inlet 10. The other end of the processing gas supply line 11 is coupled to a processing gas supply source 12, and a mass flow controller 13 and an opening/closing valve 14 are provided on the processing gas supply line 11 at the downstream side of the processing gas supply source 12. The processing gas supply source 12 supplies a processing gas, e.g., a hydrogen gas, capable of generating radicals by a contact with the catalytic heating element 8 to thereby perform a desired process by a chemical action. The processing gas supply source 12 and so forth form a processing gas supply mechanism for supplying the processing gas into the processing chamber 2.

Meanwhile, gas exhaust ports 15a and 15b are provided at bottom portions of the processing chamber 2. The gas exhaust port 15a is connected to a dry pump (DP) 17 via a turbo molecular pump (TMP) 16, while the gas exhaust port 15b is connected to the dry pump 17 via an auto pressure controller (APC) 18. In addition, an opening/closing valve 19 is installed between the gas exhaust portion 15a and the TMP 16.

Further, the APC 18 and the DP 17 are used to create a vacuum atmosphere (for example, a vacuum level of about 26.6 Pa to 665 Pa (about 200 mTorr to 5 Torr)) in the processing chamber 2 when processing the semiconductor wafer W, for example. Meanwhile, the TMP 16 is used to evacuate the processing chamber 2 to create a high vacuum therein, thereby removing substances (for example, moisture) adhered to the inner wall of the processing chamber 2, when preparing to begin a substrate processing in the processing chamber 2 which has been set to be under an atmospheric pressure and opened to atmosphere for the purpose of a maintenance/repair work or the like. At this time, if the temperature in the processing chamber 2 is increased by applying an electric power to the catalytic heating element 8, the removal of the adhered substances can be accomplished rapidly.

A plate-shaped member 20 is disposed between the catalytic heating element 8 and the semiconductor wafer W to be processed in the processing chamber 2. The plate-shaped member 20 is made of a material capable of transmitting the radiant heat from the catalytic heating element 8, for example, quart or the like. Further, the plate-shaped member 20 is provided with a number of through holes 21 through which the radicals are supplied to the semiconductor wafer W in a shower-like manner.

While functioning to uniformly supply the processing gas containing the radicals, which are generated as a result of the contact of the processing gas with the catalytic heating element 8, to the semiconductor wafer W in the shower-like manner, the plate-shaped member 20 also functions to prevent dispersed materials from a resist film formed on the surface of the semiconductor wafer W from being adhered to the catalytic heating element 8. Further, to enhance the function of preventing the adherence of the dispersed materials, when performing the substrate processing by evacuating the processing chamber 2 by means of the DP 17 after supplying the processing gas into the processing chamber 2 from the processing gas supply source 12, a pressure difference occurs by setting an internal pressure of the processing chamber 2 on the upper side (on the side of he catalytic heating element 8) of the plate-shaped member 20 higher than an internal pressure of the processing chamber 2 on the lower side (on the side of the supporting pins 3) of the plate-shaped member 20.

Moreover, provided at a sidewall portion of the processing chamber 2 is an opening 22 through which the semiconductor wafer W is loaded into and unloaded from the processing chamber 2. Disposed at the opening 22 is a gate valve 23 for sealing the opening 22 airtightly.

The whole operation of the substrate processing apparatus 1 having the above-described configuration is controlled by a control unit 60. The control unit 60 includes a process controller 61 having a CPU for controlling each component of the substrate processing apparatus 1, a user interface 62 and a memory unit 63.

The user interface 62 includes a keyboard for a process manager to input a command to operate the substrate processing apparatus 1; a display for showing an operational status of the substrate processing apparatus 1; and the like.

The memory unit 63 stores therein recipes including, e.g., processing condition data and control programs to be used in performing various processes in the substrate processing apparatus 1 under the control of the process controller 61. When necessary, a recipe is retrieved from the memory unit 63 and executed by the process controller 61 by a command input from the user interface 62, whereby a desired process is performed in the substrate processing apparatus 1 under the control of the process controller 61. The recipe such as the control programs, the processing condition data and the like can be retrieved from a computer-readable storage medium (e.g., a hard disk, a CD, a flexible disk, a semiconductor memory, and the like), or can be used on-line by being transmitted from another apparatus via, e.g., a dedicated line, whenever necessary.

Now, a process of processing a semiconductor wafer W, which is performed by the substrate processing apparatus 1, will be explained. First, after the gate valve 23 of the opening 22 is opened, the semiconductor wafer W is loaded into the processing chamber 2 from a load lock chamber (not shown) and is mounted on the supporting pins 3. Then, the gate valve 23 is closed, and the processing chamber 2 is evacuated to a specific vacuum level (for example, about 26.6 Pa to 665 Pa (about 200 mTorr to 5 Torr)) by the APC 18 and the DP 17.

Thereafter, the catalytic heating element 8 is heated up to a temperature of, e.g., about 1000° C. or greater by applying a DC power to the catalytic heating element 8 from the DC power supply 9. At the same time, by moving the supporting pins 3 vertically by means of the driving mechanism 4, the semiconductor wafer W is brought close to the catalytic heating element 8 at a certain distance, so that the semiconductor wafer W is heated by heat radiated from the catalytic heating element 8 up to a specific temperature. Then, the opening/closing valve 14 is opened, and a processing gas (e.g., a hydrogen gas) is introduced into a ceiling space of the processing chamber 2 from the processing gas supply source 12 via the processing gas supply line 11 and the processing gas inlet 10, while its flow rate is being controlled by the mass flow controller 13. At this time, the internal pressure of the processing chamber 2 is maintained at a specific pressure level.

The processing gas introduced into the ceiling space of the processing chamber 2 contacts the catalytic heating element 8 heated up to the high temperature, whereby radicals of the processing gas are generated by a catalytic action of the catalytic heating element 8. The processing gas containing the radicals is uniformly supplied to the semiconductor wafer W through the through holes 21 of the plate-shaped member 20 in the shower-like manner, so that a desired process, for example, an ashing process is performed on the semiconductor wafer W chemically by the action of the radicals.

Though a resist material or the like may be dispersed from the semiconductor wafer W while the ashing process or the like is performed, adherence of the dispersed material to the catalytic heating element 8 can be prevented by the presence of the plate-shaped member 20, as described above. As a result, degradation of the catalytic heating element 8 can be prevented.

When the desired process is completed, the power supply from the DC power supply 9 and the processing gas supply from the processing gas supply source 12 are stopped, and the semiconductor wafer W is unloaded from the processing chamber 2 in the reverse sequence to that described above.

As described above, since the substrate processing apparatus 1 is configured to heat the semiconductor wafer W up to the specific temperature by the heat radiated from the catalytic heating element 8, it is unnecessary to install a conventionally used resistance heater (for example, a ceramic heater or the like) to heat the semiconductor wafer W. Therefore, manufacturing costs of the substrate processing apparatus 1 can be greatly reduced in comparison with conventional cases. Moreover, since it is not required to supply a power to the resistance heater to heat the semiconductor wafer W, energy consumption can be reduced in comparison with the conventional cases, so that costs for the substrate processing can be attenuated.

While the invention has been shown and described with respect to the embodiment, it will be understood by those skilled in the art that various changes and modifications may be made without departing from the scope of the invention as defined in the following claims.

What is claimed is:

1. A substrate processing apparatus comprising:
a processing chamber for accommodating and processing a target substrate therein;
a supporting member for supporting the target substrate in the processing chamber;
a processing gas supply mechanism for supplying, into the processing chamber, a processing gas which generates radicals for processing the target substrate;
a catalytic heating element disposed to face the target substrate, the catalytic heating element radiating heat when an electric power is applied thereto and generating the radicals by a catalytic action as the processing gas contacts the catalytic heating element;
a power supply mechanism for supplying the power to the catalytic heating element to allow the catalytic heating element to radiate the heat; and
a driving mechanism for moving the target substrate close to or apart from the catalytic heating element by means of moving the supporting member, to thereby control a temperature of the target substrate.

2. The substrate processing apparatus of claim 1, wherein a plate-shaped member made of a material capable of transmitting the radiant heat from the catalytic heating element is disposed between the catalytic heating element and the supporting member, and the plate-shaped member is provided with a number of through holes for allowing the radicals to pass therethrough.

3. The substrate processing apparatus of claim 2, wherein an internal pressure of the processing chamber on the catalytic heating element side of the plate-shaped member is set to be higher than an internal pressure of the processing chamber on the supporting member side of the plate-shaped member.

4. The substrate processing apparatus of claim 2, wherein the plate-shaped member is made of quartz.

5. The substrate processing apparatus of claim 1, wherein the catalytic heating element is made of a material selected from a group including W, SiC and Pt.

6. The substrate processing apparatus of claim 1, wherein the processing gas is a hydrogen gas.
